(19) United States
(12) Patent Application Publication
(10) Pub. No.: US 2009/0103766 A1
(43) Pub. Date: Apr. 23, 2009

(54) Method and Apparatus for Providing an Expandable Accoustical Volume

(76) Inventors: Jørgen Daucke, Struer (DK); Kresten Krab-Johansen, Struer (DK)

Correspondence Address: HARNESS, DICKEY & PIERCE, P.L.C., P.O. BOX 8910, RESTON, VA, 20195, US

(21) Appl. No.: 11/922,201

(22) PCT Filed: Jul. 4, 2006
(86) PCT No.: PCT/DK2006/000394

§ 371 Date: May 21, 2008

(30) Foreign Application Priority Data
Jul. 11, 2005 (DK) PA 2005 01020

(51) Int. Cl. H04R 1/02

(52) U.S. Cl. 381/386

(57) ABSTRACT

A speaker system with an inner element movable in relation to an outer element, where an expanded position is one in which the inner volume of the housing is large and where a speaker is exposed for providing audio. In a contracted position, the volume is smaller and the speaker is protected inside the outer clement. This may be provided in a media player (MP3 player) which in the contracted mode provides a signal for headphones, but which in the expanded mode provides the signal to the speaker of the speaker system.

### BACKGROUND OF THE INVENTION

There is a huge demand for compact quality equipment dedicated to media presentation whether this is for accessing information from the internet or from physical information services like disks and memory devices. It's a major challenge to present the information whether its sound (audio) or picture (video) in a reasonable quality despite the limited resources of the presentation unit in terms of small screen size and poor speaker and amplifier capacity.

Head-/earphones attached either directly to the equipment or via a wireless connection like a Blue Tooth link are most commonly used for audio sound presentation in the compact equipment like phones, mobile phones, media players (MP3, DVD).

The poor acoustical sound performance is due to combinations of the small/tiny transducers with a limited frequency response, and especially with very little bass performance. A major factor in the problem is that the speaker operates with very little space behind the speaker membrane, causing an acoustical resistance and reflections to the membrane of the transducer, hindering the free movement thereof.

EP-A-1 207 717, US 2005/0031148, and U.S. Pat. No. 6,243,260 illustrate speakers with a variable volume or speakers which may be translated into a protective element.

### SUMMARY OF THE INVENTION

In a first aspect, the invention relates to a speaker system comprising at least one speaker having a speaker membrane or cone and being positioned in a housing comprising:
an outer element having a cavity and having an opening into the cavity,
an inner element having a cavity and having an opening into the cavity, the inner element having a first part adjacent to the opening and a second part, preferably adjacent to the first part,
   the inner element being movable in relation to the outer element between a first position and a second position:
the first position being one wherein the opening and the first part of the inner element is positioned in the cavity of the outer element, and where the second part of the inner element is positioned outside the cavity of the outer element,
the second position being one wherein the opening, the first part, as well as the second part of the inner element is positioned in the cavity of the outer element,
   wherein the speaker is positioned so as to provide sound through the second part of the inner element.

Consequently, the sound output of the second part, whether represented by one or more openings through which the sound from the speaker membrane/cone is output or whether the speaker membrane/cone itself is positioned at that position, is concealed or protected within the outer element when in the second position, whereas it is revealed or exposed when in the first position.

In addition to that, an inner volume of the housing as defined by the combined cavities of the outer and inner elements is larger in the first position than in the second position. Thus, a better sound quality of the speaker may be obtained in the first position where the sound output is also exposed.

In this connection, it may be desired to provide a sound-proof barrier or other type of barrier between the inner and outer elements in order to have the inner volume thereof function as a back chamber for the speaker. In that relation, this barrier should be able to accommodate the relative movement between the inner and outer elements. Also, it is preferable that at least the second part of the inner element has a cross-section fitting within the opening of the outer element and which is at least substantially constant along the direction of movement between the first and the second positions. Thus, it will be easier to provide a barrier or seal between the outer element and the inner element in order to close the interior volume thereof.

Also, one of the inner and outer elements may comprise a vent or reflex port as is known in relation to speaker cabinets.

The second position is a more compact position suitable for e.g. transporting the system in a manner so that the sound output or speaker membrane/cone is protected.

Naturally, any number of speakers may be provided. In the situation where multiple speakers are present, it is preferred that the sound output or speaker membranes/cones of all speakers are positioned in the second part of the inner element in order for all of these to be protected during transportation.

In the present context, the speaker may be any type of speaker adapted to convert an electrical signal into sound. Such speakers may have sound generating means e.g. called a membrane, diaphragm or cone, depending on the size of the speaker and the shape of the sound generating means. Oftentimes, such sound generating means are quite sensitive to touch/scratches/pull/push, so that it is desired that these are protected during transportation.

In addition, the sound output may be the actual membrane/cone/diaphragm directly exposed, or it may be one or more openings, such as defined by holes in a casing or by a grating, covering or protecting the membrane/cone/diaphragm in a manner so that sound may still be output in a sufficient quality.

In this context, the relative positions of the opening, the first part, and the second part of the inner element are such that the opening and the first part always can be present in the outer element. Thus, the first part is adjacent to the opening. Further away from the opening than the first part, the second part is positioned so that it may be brought into and out of the outer element, depending on the use of the present system. As will be made clear further below, the actual movement from the first to the second position may be made in a number of manners, so that the actual positions of the first and second parts may vary widely from embodiment to embodiment.

In one embodiment, the system further has means for controlling a signal transmitted to the speaker, the controlling means being positioned in the second part of the inner element. Thus, controls particularly interesting when listening to audio on the speaker may be hidden/protected within the outer element, when the system is not in use or it is not used for providing audio using the speaker. Such controls could be for controlling the volume of the audio provided. Naturally, these controls may also comprise a display, such as for providing information to the user relating to the audio provided.

In another embodiment, the system may have means for determining whether the inner element is in the first or the second position. Such means may be used for turning off means for providing a signal to the speaker, in order to save power (such as from a battery). This may be particularly interesting, when the present system is a media player comprising also a storage holding media to be played, as well as e.g. an amplifier for feeding the speaker.

In this situation, the system may further comprise means for providing a signal to a second speaker, the providing means being operable only when the inner element is in the second position. This second speaker could be an external speaker, such as a larger speaker which is not or less portable than the present system is adapted to be. Alternatively, the second speaker could be ear/headphones, which may be useful when it is not desired to listen to audio using the speaker. Thus, in the second, more compact, position, ear/headphones could be used, whereas, when exposing the sound outlet, the speaker is then used, and the output to the second speaker is cut off.

In this respect, an electrical signal may be transmitted via electrical conductors from an amplifier in the system for an external speaker which may or may not be an active speaker. Alternatively or additionally, the signal may be provided over a wireless link to active speakers.

The actual movement between the inner and outer elements will depend on a number of desires, such as the design, operation, shape, number of speakers, distribution of the audio from the speaker(s), desired volume increase of the inner space etc. of the housing. Thus, the inner and outer elements may be adapted to be movable in relation to each other by a translational and/or rotational movement.

In higher quality products, it may be desired to also provide means for moving the inner element between the first and second positions in relation to the outer element. Such means may be a motor/actuator and/or a spring—or a combination of both. Actuating/controlling means for these means may be provided anywhere desirable.

As mentioned, the speaker may provide the sound through an opening in the inner element provided in the second part of the inner element, through another element (such as a grating also providing protection), or the speaker may be directly positioned/exposed in the second part of the inner element.

In a second aspect, the invention relates to a method of operating the above speaker system, the method comprising moving the inner element from the second position to the first position in order to expose the second part of the inner element and increase an inner volume of the housing. In this respect, the inner volume is the volume defined by the combined cavities of the inner and outer element through the opening of the inner element. It is clear that the effective volume of the cavity of the outer element differs from the first to the second position in that this cavity, in the second position, accommodates more of the inner element.

Naturally, this method may also comprise the steps of operating the other means described above, such as the controls for the output of the speaker and the means for bringing the elements into the first or second positions.

A third aspect relates to a method of operating the speaker system comprising means for providing a signal to a second speaker, the providing means being operable only when the inner element is in the second position, the method comprising determining that the inner element is in the second position and providing a signal to a second speaker positioned outside the housing. In this manner, a signal is provided to the speaker of the system in the first position and only to any external speakers when the system is in the second position.

### SHORT DESCRIPTION OF THE FIGURES

In the following, preferred embodiments will be described in relation to the drawing, wherein:

FIG. 1 gives an example of a device with an expandable acoustical volume according to a first embodiment of the invention comprising one speaker.

FIG. 2 gives an example of a device with an expandable acoustical volume according to a second embodiment of the invention comprising two speakers.

FIG. 3 gives an example of a device with an expandable acoustical volume according to a third embodiment of the invention wherein an alterative expansion principle is applied.

FIG. 4 illustrates the cross sectional area of a device, according to the invention, wherein alternative mechanical body designs are applied.

FIG. 5 gives an example of a device with an expandable acoustical volume according to one embodiment of the invention wherein one speaker, a display and additional control buttons is contained.

FIG. 6 illustrates different alternative embodiments of the invention.

### DETAILED DESCRIPTION

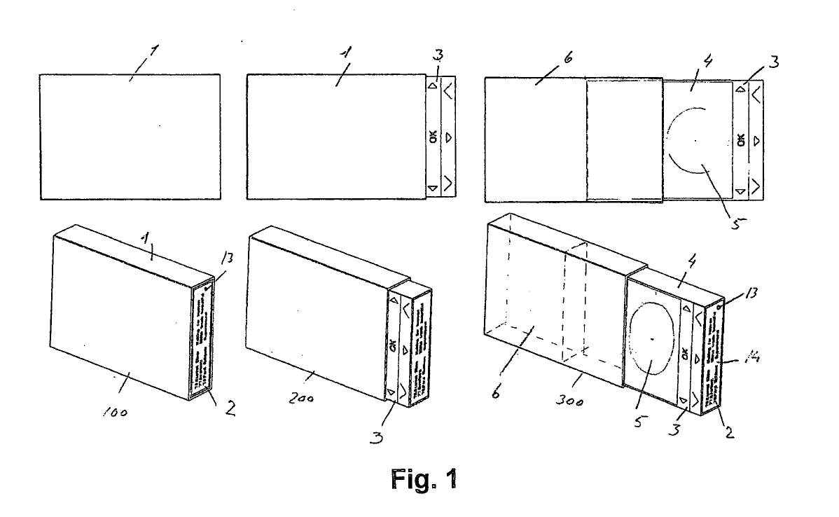

According to the embodiment of FIG. 1, a device (1) with an expandable acoustical volume (6) is provided. The mechanical part of the expansion feature enables the device to operate in different modes: non-expanded (100), partly expanded (200), and fully expanded (300).

According to one embodiment, the device is a portable media player (1), wherein a loudspeaker (5) is mounted, a status display (2) is disposed on the surface of the unit and buttons for the operational control is located on the surface of the expanded unit (3) and optionally few buttons fully disposed on the front (14), e.g. one button to toggle the start/stop function of the player (13).

In this embodiment, the acoustical volume (6) is extended by moving an inner part or element (4) as a drawer to the expanded position, whereby the volume previously taken op by a part of the inner element is now released to take part in the effective acoustical volume. In the fully expanded mode (300), the built-in speaker (5) is completely exposed to the environmental air and operates supported by the acoustical volume and the housing of the device that constitutes the actual cabinet of the speaker.

The acoustical volume (6) is extended by moving an inner part (4) as a drawer to the expanded position as a result of user activation on the surface of the device (14). The preferred means for this drawer activation is a simple click mechanism enabling the functions: a) a push to open and release the drawer, and b) a push to close and lock the drawer, until a new push to re-open is given by the user.

Preferably, means for stereophonic play back is provided in the unit. This includes stereo amplifiers and a dual speaker configuration (7). To obtain the maximum benefits of the stereo setup, the extended acoustical volume is subdivided into two identical sub-spaces separated by a mechanical device (8) that's automatically brought into position when the inner part is moved to the extended position. To further enhance the acoustical performance, a port (9) is established to the open air (10). This port is optimized to the acoustical volume with a dedicated adjustment to each of the stereophonic channels, i.e. into each of the left-right acoustical sub-volumes.

Mechanical means support the transition of an object having a specific volume from a compact mode to a fully expanded mode with an extended volume.

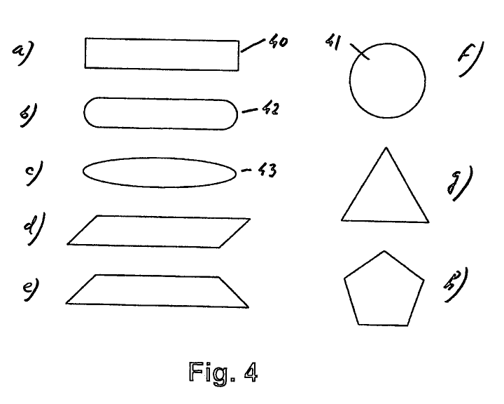

The outer shape of the unit can have any geometrical form (FIG. 4) the circle, ellipse, square, rectangle, rounded rectangle, triangle, trapezium, parallelogram and polygon. Preferably, the cross-sectional shape is a rectangle (40).

According to a third embodiment, the cross-sectional shape is a circle (41). According to this embodiment the acoustical volume (36) is extended by moving the inner parts (32, 33) as embedded drawer elements from the compact position (30) to the expanded position (31), where by releasing the volume of the inner parts moved, to be a part of the effective acoustical volume (37).

In one situation, the acoustical volume (36) is extended by moving the inner parts (32, 33) as a drawer from the compact position (30) to the expanded position (31). The preferred means for this drawer activation is a simple click mechanism enabling the function button (35): a) a push to open and release the drawer, and b) a push to close and lock the drawer, until a new push to re-open is given by the user.

In another situation, the activation of the drawer mechanism is obtained by turning a wheel-shaped button (38) disposed on the front plate of the unit. E.g. the button is turned clockwise and anticlockwise to close/open the drawer position correspondingly.

Again, it is seen that the sound output of the speakers 34 is protected in the compact mode. Also in this embodiment, means may be provided for stereophonic play back. This includes stereo amplifiers and a dual speaker configuration (34).

In general, means may be provided for extended information control and presentation. Compared with the status display (2), a graphical screen (11), e.g. of type LCD, OLED or plasma, increases the display capacity. Further additional buttons (12) may be disposed on the surface of the drawer unit to support a plurality of navigation functions e.g. to support browsing through menu information presented on the screen (11). These navigation buttons can be of any standard type, like push buttons, touch pad, rotating wheel, or joy-stick types.

Also, means for automated ejection of the drawer mechanism (4), supported by a motor drive, may be implemented. This as an alternative to a command given by the user activating the eject button (14). This automated function is activated e.g. when the media player is placed into a kind of docking station, enabling the unit to make the transition from the compact mode (100) into the fully expanded mode (300), where by the better acoustical sound quality is obtained.

FIG. 1 gives an example of the media player unit (1) according to one preferred embodiment of the invention. The physical appearance of the device is that the cross sectional shape is a rectangle (40) or a rounded rectangle (42). The device is equipped with one speaker (5) that is fully exposed on the surface of the drawer unit (4), when this is brought into the extended position (300).

The device (1) is brought from the compact mode (100) to the partly expanded mode (200) by pushing slightly on the front of the player unit (14). In this mode of operation, the speaker output is not enabled, but the sound output is delivered to a set of attached head/ear phones.

In the partly extended mode (200) a plurality of control buttons is disposed (3) for the comfort of the user in controlling the play back of a sound source on the device (1).

The control status and information of the media currently under playback is presented on the display disposed on the front of the device (2). The play-back function is commanded to start/stop by pushing a button on the front (13), which button can be activated in any of the modes: non-expanded (100), partly expanded (200), and fully expanded (300).

The device (1) is brought from the partly expanded mode (200) to the fully expanded mode (300) by pushing slightly on the front of the player unit (14). In this mode of operation the speaker (5) output is enabled and the acoustical volume (6) is extended to its maximum.

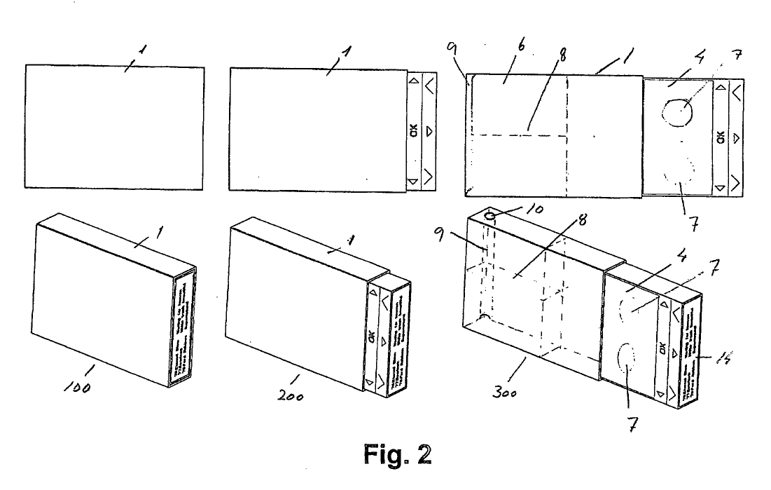

FIG. 2 gives an example of the media player unit (1) according to another preferred embodiment of the invention. The device is equipped with two speakers (7) that are fully exposed on the surface of the drawer unit (4), when this is brought into the extended position (300).

The two-speaker set up makes it possible to implement a stereophonic configuration with two sound channels. To optimize the acoustical output the extended acoustical volume (6) is subdivided into two volumes, - one per channel, separated by a mechanical arrangement (8). This mechanism acts like a hinged flap that's erected when the drawer (4) is in the extended position (300) and which is non-erected when the drawer is in the compact (100)—or in the partly extended position (200). Another implementation example of the space separator (8) is a curtain-like means that's pulled into position when the drawer (4) is in the fully extended position (300).

To further enhance the acoustical performance and sound quality, a port (10) to the open air is implemented. This port is adjusted to have the length (9) and the dimension that's optimizing the output of the stereo channels left/right individually.

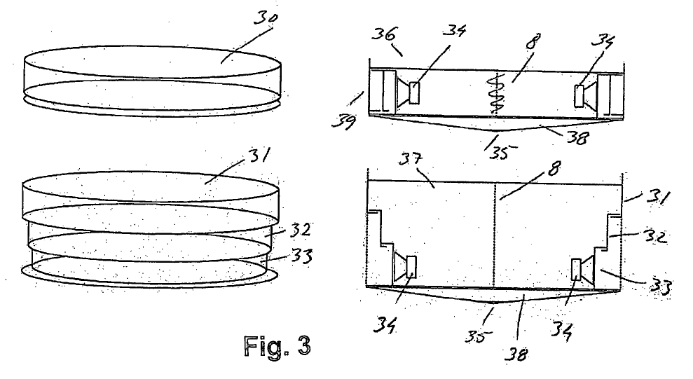

FIG. 3 gives an example of a method of acoustical volume expansion according to a third embodiment of the invention. The physical appearance of the device is with a cross sectional shape of a circle (41) or an ellipse (43). The device is equipped with one or two speakers (34) positioned so as to emit sound at a periphery of one of the circular elements 32 or 33.

The expansion elements of the device (39) are brought from the compact mode (30) into the fully expanded mode (31) by relocating the coaxial elements (32, 33) into their individual extended positions. Two or more expansion units can be implemented; in the given example three rings constitutes the expansion capacity (31, 32, 33).

According to specific shapes related to an actual unit, several expansion possibilities exist. For example having a unit with four expansion elements, the unit can be expanded with one element, with two elements, with three elements, or be fully expanded with all four elements.

The two-speaker set up makes it possible to implement a stereophonic configuration with two sound channels. To optimize the acoustical output, the extended acoustical volume (37) is subdivided into two volumes, - one per channel, separated by a mechanical arrangement (8), where the implementation of the space separator (8) is a curtain-like means that's pulled into position when the unit (4) is in the fully extended position (31).

Alternative mechanical means for initiating the transition from the compact mode into the fully expanded mode can be implemented. According to one embodiment of the invention, a front grill (38) disposed on the surface acts as a knob that may be turned. E.g. turning the knob anti-clockwise initiates a volume expansion and turning it clockwise causes the unit to return back to the non-exposed position (30). Another implementation includes a simple push option on the front (35), where e.g. one simple push initiates the expansion; another simple push continues the expansion until it is fully extended (31), from which position a new push brings the unit back to non-expanded position (30).

FIG. 4 gives some examples of alternative cross sectional shapes that might be applied in different embodiments of the invention. The outer shape of a unit (1) and the inner shape of the drawer (4) mechanism fit into one and another normally having the same shape. All geometrical forms are candidates like: a) rectangle/square, b) rounded rectangle, c) ellipse, d) trapezium, e) parallelogram, f) circle, g) triangle, and h) polygon.

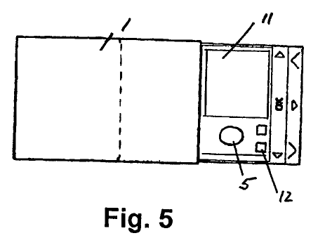

FIG. 5 gives an example of the media player unit (1) according to yet another embodiment of the invention. The device is equipped with a graphical display (11) and additional buttons (12) that are fully exposed on the (second) part or surface of the drawer unit (4) which is exposed, when this is brought into the extended position (300). This graphical display feature can support the user more effectively when navigating through structures of information e.g. play list in media player and lists of phone numbers and names. That kind of list is normally presented in a hierarchy, and browsing is simplified via dedicated navigation buttons (12) for the benefits of the user.

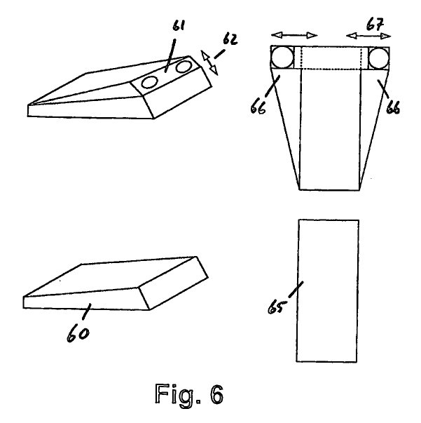

FIG. 6 gives some examples of media player units that might be implemented in different embodiments of the invention. In all the examples, the effective acoustical volume is increased when the unit is in the fully expanded mode.

In one embodiment of the invention, a rotation (62) around a vertical axis brings the unit from the compact mode (60) into the expanded mode (61) increasing the acoustical volume accordingly and revealing the speakers.

In another embodiment of the invention a rotation (67) around a horizontal axis brings the unit from the compact mode (65) into the expanded mode (66) increasing the acoustical volume accordingly and revealing the speaker(s).

1. A speaker system comprising at least one speaker having a speaker membrane or cone and being positioned in a housing comprising:
an outer element having a cavity and having an opening into the cavity,
an inner element having a cavity and having an opening into the cavity, the inner element having a first part adjacent to the opening and a second part,
the inner element being movable in relation to the outer element between a first position and a second position:
the first position being one wherein the opening and the first part of the inner element is positioned in the cavity of the outer element, and where the second part of the inner element is positioned outside the cavity of the outer element,
the second position being one wherein the opening, the first part, as well as the second part of the inner element is positioned in the cavity of the outer element,
wherein the second part of the inner element has a sound output and wherein the speaker is positioned so as to provide sound through the sound output.

2. A speaker system according to claim 1, the system further comprising means for controlling a signal transmitted to the speaker, the controlling means being positioned in the second part of the inner element.

3. A speaker system according to claim 1, further comprising means for determining whether the inner element is in the first or the second position.

4. A speaker system according to claim 3, the system further comprising means for providing a signal to a second speaker, the providing means being operable only when the inner element is in the second position.

5. A speaker system according to claim 1, wherein the inner and outer elements are adapted to be movable in relation to each other by a translational movement.

6. A speaker system according to claim 1, wherein the inner and outer elements are adapted to be movable in relation to each other by a rotational movement.

7. A speaker system according to claim 1, further comprising means for moving the inner element between the first and second positions in relation to the outer element.

8. A speaker system according to claim 1, wherein the speaker is positioned in the second part of the inner element.

9. A method of operating the speaker system according to claim 1, the method comprising moving the inner element from the second position to the first position in order to expose the second part of the inner element and increase an inner volume of the housing.

10. A method of operating the speaker system of claim 4, the method comprising determining that the inner element is in the second position and providing a signal to the second speaker positioned outside the housing.
